(19) United States
(12) Patent Application Publication
(10) Pub. No.: US 2025/0279608 A1
(43) Pub. Date: Sep. 4, 2025

(54) ELECTRICAL CONNECTOR

(71) Applicant: I-PEX Inc., Kyoto-shi (JP)

(72) Inventor: Koichi TSUSU, Shizuoka-shi (JP)

(21) Appl. No.: 19/047,423

(22) Filed: Feb. 6, 2025

(30) Foreign Application Priority Data
Mar. 1, 2024 (JP) 2024-030969

(51) Int. Cl. H01R 13/46; H01R 12/72

(52) U.S. Cl. CPC H01R 13/46; H01R 12/722; H01R 2201/26

(57) ABSTRACT

Side wall portions of a male connector that define a housing space includes first recesses having a shape of a groove extending along an insertion direction. A female connector includes a first protrusion that has a shape of a convexity extending along the insertion direction, and fitting in the first recess. The first recess of the male connector includes an inclined surface, the inclined surface being inclined relative to the insertion direction. The male connector and the female connector satisfy relation equations

$$A > α \times B \qquad ( 1 )$$

$$( where 1 \leq α \leq 1.0641 )$$

$$25 ° \leq Y \leq 45 ° \qquad ( 2 )$$

provided that a dimension of the groove of the first recess is A, a dimension of a width of the first protrusion is B, and an inclination angle of the inclined surface relative to the insertion direction is Y.

### CROSS-REFERENCE TO RELATED APPLICATIONS

This application claims the benefit of Japanese Patent Application No. 2024-30969, filed on Mar. 1, 2024, the entire disclosure of which is incorporated by reference herein.

### FIELD OF THE INVENTION

This application relates to an electrical connector.

### BACKGROUND OF THE INVENTION

Japanese Unexamined Patent Application Publication No. 2002-289302 discloses an electrical connector including a plug connector and a socket connector. In the electrical connector disclosed in Japanese Unexamined Patent Application Publication No. 2002-289302, the plug connector is a male connector, and the socket connector is a female connector that is electrically connected by being inserted into an insertion port of the plug connector.

The electrical connector has a problem that, if the socket connector is inserted to the plug connector in a significantly inclined state, an insertion slot of the plug connector deforms in a direction that widens the insertion slot, causing damage to the plug connector.

The present disclosure has been made in consideration of the above-described circumstances, and an objective of the present disclosure is to provide an electrical connector including a pair of connectors that are fitted together and suppressing damage caused upon inserting one of the pair of connectors into the other of the pair of connectors.

### SUMMARY OF THE INVENTION

In order to achieve the aforementioned objective, an electrical connector according to the present disclosure includes:
a male connector in which a housing space and an opening leading from the housing space to an outside are formed; and
a female connector to be inserted into the male connector from the opening of the housing space in an insertion direction, wherein
the male connector includes surface portions that define the housing space, the surface portions including a first recess that has a shape of a groove extending along the insertion direction,
the female connector includes a first protrusion that has a shape of a convexity extending along the insertion direction, and fits in the first recess,
the first recess of the male connector includes an inclined surface, the inclined surface being inclined relative to the insertion direction, and
the male connector and the female connector satisfy relation equations

$$A > α \times B \qquad ( 1 )$$

$$( where 1 \leq α \leq 1.0641 )$$

$$25 ° \leq Y \leq 45 ° \qquad ( 2 )$$

provided that a dimension of the groove of the first recess is A, a dimension of a width of the first protrusion is B, and an inclination angle of the inclined surface relative to the insertion direction is Y.

The present disclosure can suppress damage that may occur upon insertion of a female connector into a male connector.

### BRIEF DESCRIPTION OF THE DRAWINGS

A more complete understanding of this application can be obtained when the following detailed description is considered in conjunction with the following drawings, in which:

FIG. 1 is a first exploded perspective view of an electrical connector according to Embodiment 1 of the present disclosure;

FIG. 2 is a second exploded perspective view of the electrical connector according to Embodiment 1;

FIG. 3 is a back view of the electrical connector according to Embodiment 1;

FIG. 4 is a plan view of the electrical connector according to Embodiment 1;

FIG. 5 is a first cross-sectional view for describing a method for manufacturing the electrical connector according to Embodiment 1;

FIG. 6 is a second cross-sectional view for describing the method for manufacturing the electrical connector according to Embodiment 1;

FIG. 7 is an exploded cross-sectional view of the electrical connector taken along an A-A cross-section of FIG. 4;

FIG. 8 is a first cross-sectional view for describing a process of inserting a female connector into a male connector in Embodiment 1;

FIG. 9 is a second cross-sectional view for describing the process of inserting the female connector into the male connector in Embodiment 1;

FIG. 10 is an exploded cross-sectional view of the electrical connector according to a comparative example;

FIG. 11 is a first exploded perspective view of an electrical connector according to Embodiment 2;

FIG. 12 is a second exploded perspective view of the electrical connector according to Embodiment 2;

FIG. 13 is a first cross-sectional view for describing a process of inserting a female connector into a male connector in Embodiment 2;

FIG. 14 is a second cross-sectional view for describing the process of inserting the female connector into the male connector in Embodiment 2; and

FIG. 15 is an exploded perspective view of an electrical connector according to Embodiment 3.

### DETAILED DESCRIPTION OF THE INVENTION

### Embodiment 1

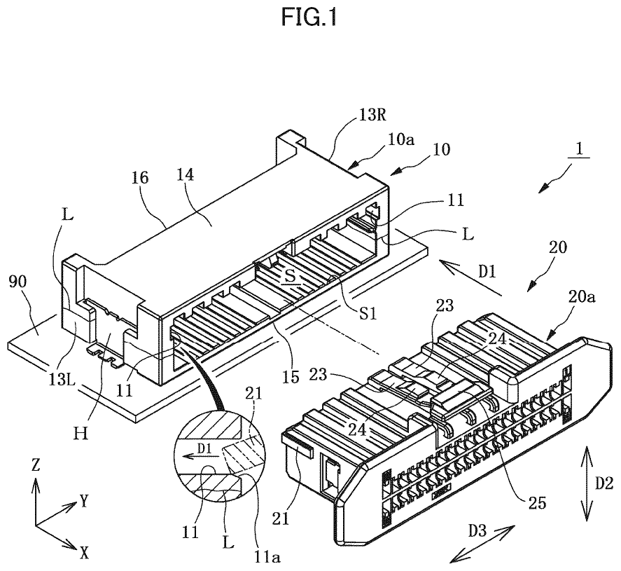

Hereinafter, an electrical connector 1 according to the embodiment of the present disclosure is described with reference to the drawings. In order to facilitate understanding, XYZ coordinates orthogonal to one another are set and are referred as appropriate. A-X direction of the XYZ coordinates is a direction same as an insertion direction D1 in which a female connector 20 is inserted into a male connector 10, as illustrated in FIG. 1. A Z-axis direction is a direction same as a height direction D2 of the electrical connector 1. A Y-axis direction is a direction same as a width direction D3 of the electrical connector 1.

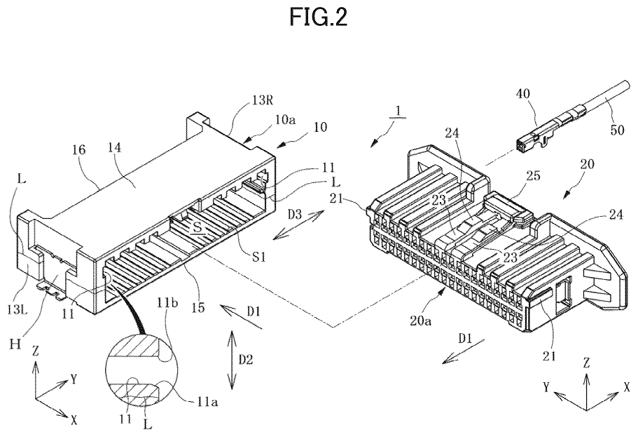

The electrical connector 1 is, for example, an electronic circuit component equipped in an automobile component. As illustrated in FIGS. 1 and 2, the electrical connector 1 includes a male connector 10 and a female connector 20.

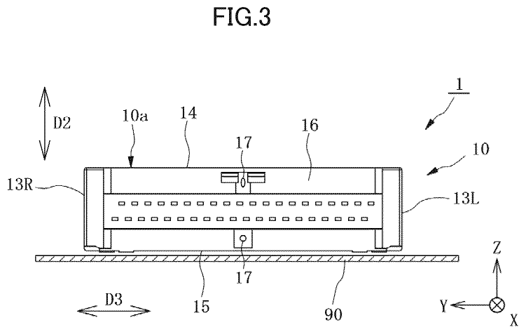

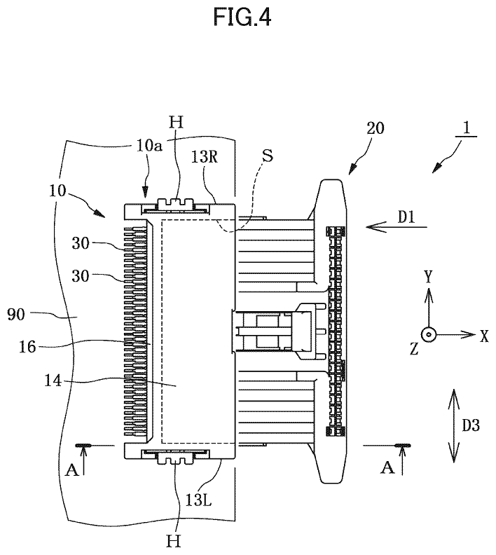

As illustrated in FIGS. 3 and 4, the male connector 10 is a connector to which the female connector 20 is fitted, and is attached to a circuit board 90 that is a device to which the male connector 10 is installed. The male connector 10 includes a housing 10a, retainers H, and male terminals 30.

As illustrated in FIGS. 1 and 2, the housing 10a has a shape of a substantially rectangular parallelepiped, and includes a pair of side wall portions 13R and 13L, a ceiling portion 14, a bottom portion 15, and a rear-side wall portion 16.

The side wall portions 13R and 13L form walls on both sides of the housing 10a in the width direction D3 of the substantially rectangular parallelepiped. A first recess 11 is provided to an inner surface of each of the side wall portions 13R and 13L. The first recess 11 has a shape of a groove extending along the insertion direction D1 (X-axis direction). The first recess 11 according to the present embodiment is provided to each of the side wall portions 13R and 13L, but is not limited thereto. For example, the first recess 11 may be provided to one of the side wall portions 13R and 13L. The first recess 11 may be provided to the surface portions other than the side wall portions 13R and 13L. For example, the first recess 11 may be provided to one or both of the ceiling portion 14 and bottom portion 15. The first recess 11 is provided to the inner surface of each of the side wall portions 13R and 13L, but is not limited thereto. The first recess 11 may be provided to an outer surface of each of the side wall portions 13R and 13L. Furthermore, the first recess 11 may be provided to an outer face of the surface portions other than the side wall portions 13R and 13L.

The ceiling portion 14 forms a portion on a +Z side of the substantially rectangular parallelepiped of the housing 10a.

The bottom portion 15 forms a surface portion on a −Z side of the substantially rectangular parallelepiped of the housing 10a. The bottom portion 15 is a surface portion in contact with the circuit board 90.

The rear-side wall portion 16 forms a wall portion on a −X side of the substantially rectangular parallelepiped of the housing 10a.

The housing 10a formed as described above has, inside the substantially rectangular parallelepiped, a housing space S and an opening S1 leading from the housing space S to the outside.

The opening S1 is formed in the housing 10a to open in a +X direction. A part of the female connector 20 is fitted into the male connector 10 through the opening S1 and is accommodated in the housing space S provided inside the housing 10a.

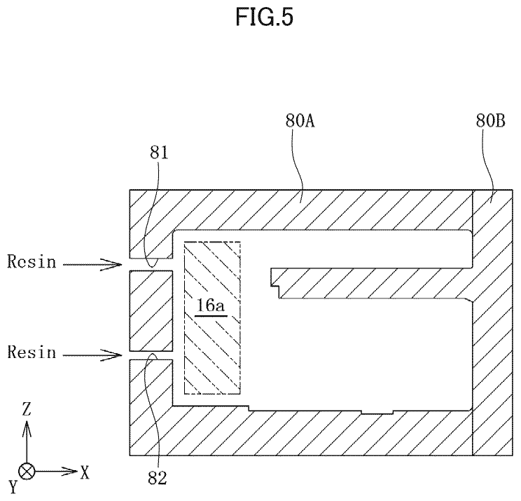

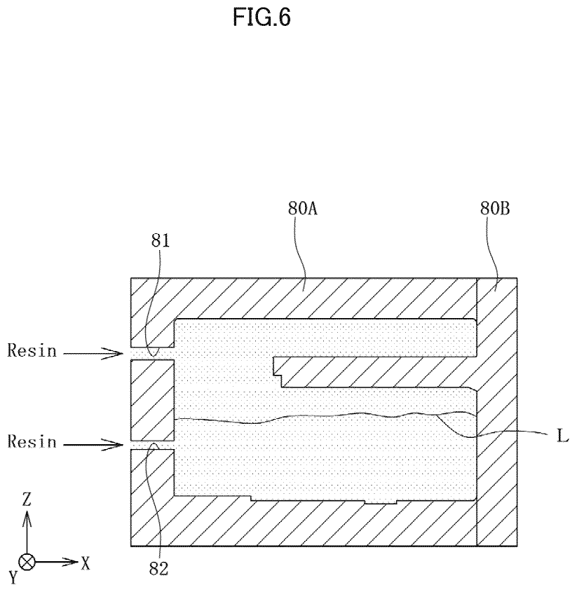

The housing 10a according to Embodiment 1 is made of a material of solidified molten resin. Specifically, the housing 10a is formed, for example, by pouring molten resin into injection molds 80A and 80B having two gates 81 and 82, followed by solidification of the molten resin, as illustrated in FIGS. 5 and 6. In Embodiment 1, the housing 10a is formed, for example, by pouring the molten resin into a portion 16a through the two gates 81 and 82. The portion 16a is a portion where the rear-side wall portion 16 (see FIGS. 1 and 2) of the housing 10a is formed. As a result, gate traces 17 are provided to the housing 10a on the rear-side surface, that is, the surface on the −X side, of the rear-side wall portion 16, as illustrated in FIG. 3. The gate traces 17 are inlets for inflow therethrough of the molten resin.

The gate traces 17 are provided at the center in the width direction D3. At least a pair of the gate traces 17 is provided along the height direction D2. The pair of gate traces 17 according to Embodiment 1 have different sizes.

Moreover, as the housing 10a is formed using the injection molds 80A and 80B (see FIGS. 5 and 6) having the two gates 81 and 82, weld lines L are formed on the side wall portions 13R and 13L of the housing 10a, as illustrated in FIGS. 1 and 2. The weld line L is a molding defect area, that is, a portion where the molten resin merges, that occurs during molding of the molten resin. The weld line L according to Embodiment 1 is a slightly wavy line that extends along the insertion direction D1.

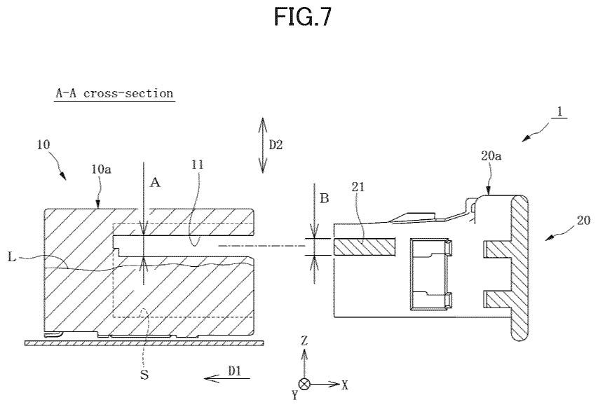

As illustrated in FIG. 7, the aforementioned first recesses 11 of the side wall portions 13R and 13L are provided on the +Z side (one side) in the height direction D2 of the male connector 10 than the positions where the weld lines L are located. Therefore, the first recess 11 is not provided at the same position as the weld line L in the height direction D2 of the male connector 10, and is provided at a position shifted in the height direction D2, more specifically, a position closer to the top than the weld line Lis. Furthermore, as illustrated in FIG. 2, an inclined surface 11a is provided on a lower edge of an opening of the first recess 11. The inclined surface 11a is inclined at a predetermined angle relative to the insertion direction D1. The inclined surface 11a is provided to facilitate the fitting of a first protrusion 21 into the first recess 11, as well as to guide the insertion of the first protrusion 21 of the female connector 20, upon insertion of the female connector 20 into the male connector 10.

As illustrated in FIGS. 1 and 2, the retainer H is a member provided on the outer surface of each of the side wall portions 13R and 13L of the housing 10a, and is fixed to the surface of the circuit board 90 that is a device to which the male connector 10 is installed. The retainer H is formed, for example, by bending a plate-shaped metal member into an L-shape. The retainers H are used to firmly fix the housing 10a to the circuit board 90.

The male terminals 30 penetrate through and are arranged to the rear-side wall portion 16 of the housing 10a, as illustrated in FIG. 4. The male terminal 30 is prepared through, for example, press working a conductive board material such as copper, copper alloy, or the like. One end of the male terminal 30 protrudes into the housing space S of the housing 10a. The other end of the male terminal 30, that is, an end on the −X side protrudes from the rear-side wall portion 16 of the housing 10a on the −X side, as illustrated in FIG. 4. The end of the male terminal 30 on the −X side is electrically connected to a conductive portion on the surface of the circuit board 90, for example, by soldering.

As illustrated in FIGS. 1 and 2, the female connector 20 includes a housing 20a, the first protrusions 21, locking arms 23, engaging sections 24, an operative tap 25, and female terminals 40.

The housing 20a is formed to be accommodatable inside the housing space S of the housing 10a of the male connector 10. Specifically, the housing 20a has a shape that corresponds to the internal shape of the housing space S of the male connector 10, and also is capable allows fitting of the female connector 20 to the male connector 10 from the opening S1. The housing 20a has terminal housing chambers for housing the respective female terminals 40.

The first protrusion 21 is provided to each of the side surface on the −Y side and the side surface on the +Y side of the housing 20a. The first protrusion 21 has a shape of a convexity elongating along the insertion direction D1, and fits in the first recess 11.

Two locking arms 23 are provided on a top surface of the housing 20a. The locking arm 23 is flexible in the height direction D2.

The engaging sections 24 are provided to each of the two locking arms 23. The engaging sections 24 protrude in the +Z direction from the respective locking arms 23. The engaging sections 24 can engage with non-illustrated engaged sections provided inside the male connector 10.

The operative tap 25 is used to disengage the engaging sections 24 from the engaged sections of the male connector 10 by a pressing operation by a user of the electrical connector 1.

The female terminals 40 are accommodated in the respective terminal housing chambers of the housing 20a, as illustrated in FIG. 2. The female terminal 40 has, for example, a cylindrical portion capable of receiving the male terminal 30 (see FIG. 4) to be connected, and a crimping portion where a cable 50 is crimped and connected. When the female terminal 40 is attached to the housing 20a, the cable 50 connected to the female terminals 40 is in a state where the cable 50 is drawn from the housing 20a.

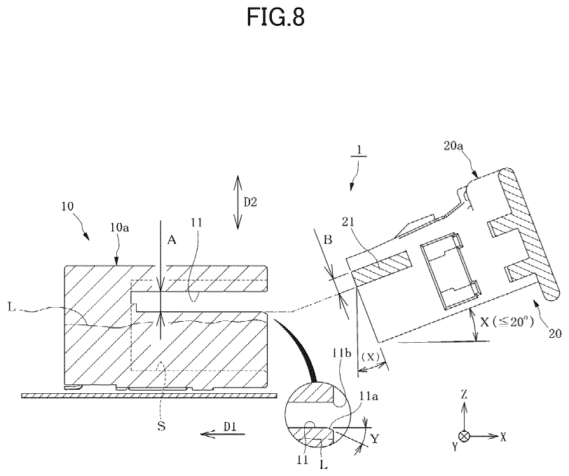

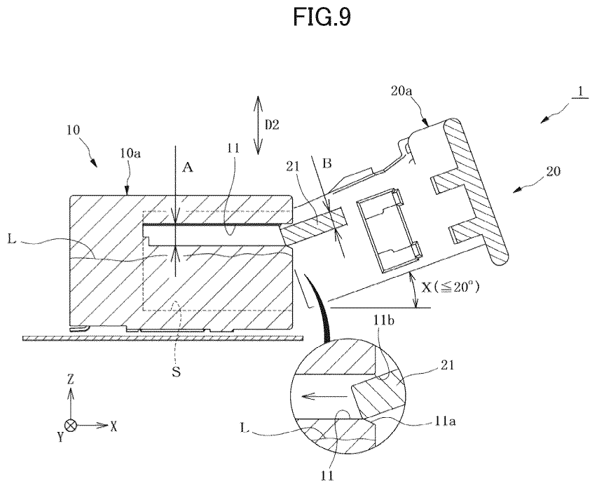

As illustrated in FIGS. 8 and 9, the electrical connector 1 with the configurations described above satisfies relation equations

$$A > α \times B \qquad ( 1 )$$

$$( where 1 \leq α \leq 1.0641 )$$

$$25 ° \leq Y \leq 45 ° \qquad ( 2 )$$

provided that a dimension of the groove of the first recess 11 is A, a dimension of a width of the first protrusion 21 is B, and an inclination angle of the inclined surface 11a relative to the insertion direction D1 is Y.

Specifically, the electrical connector 1 according to Embodiment 1 satisfies a relation equation

$$A / B = 1.0641 ( α = 1.0641 ) . \qquad ( 3 )$$

In other words, the electrical connector 1 satisfies relation equations

$$A > B / cos X \qquad ( 4 )$$

$$X \leq 20 ° \qquad ( 5 )$$

$$( X + Y ) < 45 ° \qquad ( 6 )$$

provided that an inclination angle of the female connector 20 relative to the insertion direction D1 upon insertion of the female connector 20 into the male connector 10 is X. According to the relation equation (5), it indicates that the female connector 20 is inserted into the male connector 10 with an inclination angle X of 20° or less. In the aforementioned relation equation (1), “α” indicates “secX”, that is a reciprocal of “cosX”, in other words, “α” indicates “1/cosX”. The upper limit of “α”, “1.0641”, is calculated from “1/cos 20°” (1/cos 20°≈1/0.9397≈1.0641), based on the condition that the inclination angle X of the female connector 20 is 20° or less in the aforementioned relation equation (5).

As described above, in the electrical connector 1 according to Embodiment 1, the dimension A of the groove of the first recess 11, the dimension B of the width of the first protrusion 21, and the inclination angle Y of the inclined surface 11a relative to the insertion direction D1 satisfy the aforementioned relation equations. Therefore, upon insertion of the female connector 20 into the male connector 10 as illustrated in FIGS. 1 and 2, the first protrusions 21 of the female connector 20 come in contact with the inclined surfaces 11a of the first recesses 11 of the male connector 10 to guide the female connector 20 towards the housing space S of the male connector 10 and suppress the inclination angle X of the female connector 20 relative to the insertion direction D1 to 20° or less. As such, as illustrated in FIG. 9, this makes it easier for the first protrusions 21 to contact the inclined surfaces 11a of the first recesses 11 before the first protrusions 21 contacting the upper edges 11b of the first recesses 11.

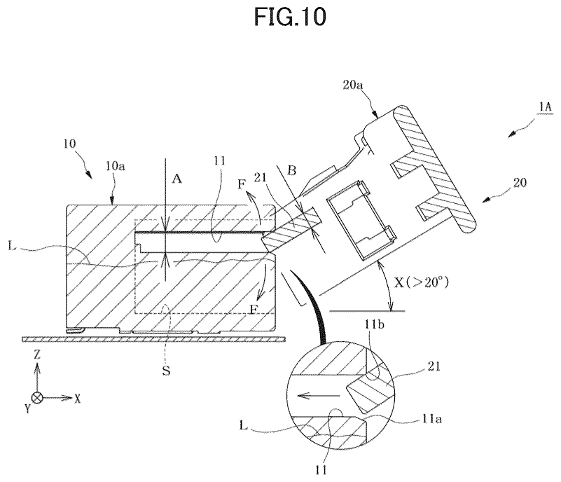

For example, in an electrical connector 1A according to a comparative example, a female connector 20 is inserted into a male connector 10 at an inclination angle X greater than 20° (X>20°), as illustrated in FIG. 10. As such, in some cases, first protrusions 21 come in contact with upper edges 11b of first recesses 11 before the first protrusions 21 contacting inclined surfaces 11a of the first recesses 11. In this case, due to the contact, for example, a force F to open in a height direction D2 is applied to the first recesses 11. This may deform an opening of the male connector 10 in a direction that widens the opening, which may cause damage such as cracks in the male connector 10. The force F may further cause splits in weld lines L.

However, in the electrical connector 1 according to Embodiment 1, the inclination angle X of the female connector 20 relative to the insertion direction D1 upon insertion of the female connector 20 into the male connector 10 is suppressed to 20° or less, as illustrated in FIGS. 8 and 9. Therefore, this makes it easier for the first protrusions 21 to contact the inclined surfaces 11a of the first recesses 11 before the first protrusions 21 contacting the upper edges 11b of the first recesses 11. As such, for example, the force F to open in the height direction D2 (see FIG. 10) is less likely applied on the first recesses 11, and thus, damage to the male connector 10 can be suppressed. As described above, in Embodiment 1, damage that may occur upon insertion of the female connector 20 into the male connector 10 can be suppressed.

In Embodiment 1, the first recesses 11 are arranged to the wall portions of the housing 10a on the +Z side in the height direction D2 compared to the position where the weld lines L are provided. That is, the first recesses 11 and the weld lines L are not provided at the same position in the height direction D2. Therefore, compared to a structure in which the first recesses 11 and the weld lines L are provided at the same position in the height direction D2, the aforementioned structure can suppress damage to the first recesses 11 and to the weld lines L. As a result, in Embodiment 1, damage that may occur upon insertion of the female connector 20 into the male connector 10 can be suppressed.

Furthermore, in Embodiment 1, the gate traces 17 are provided at the center in the width direction D3, and a pair of the gate traces 17 is provided along the height direction D2, as illustrated in FIG. 3. This makes it easier to change or adjust the position of the weld lines L in the height direction D2 in Embodiment 1.

### Embodiment 2

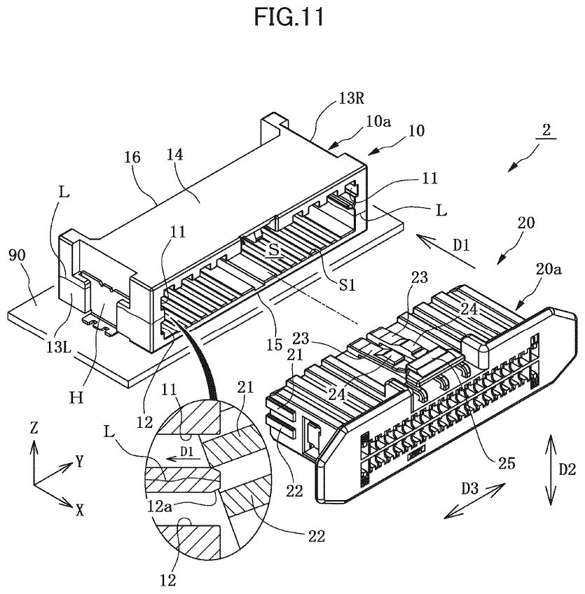

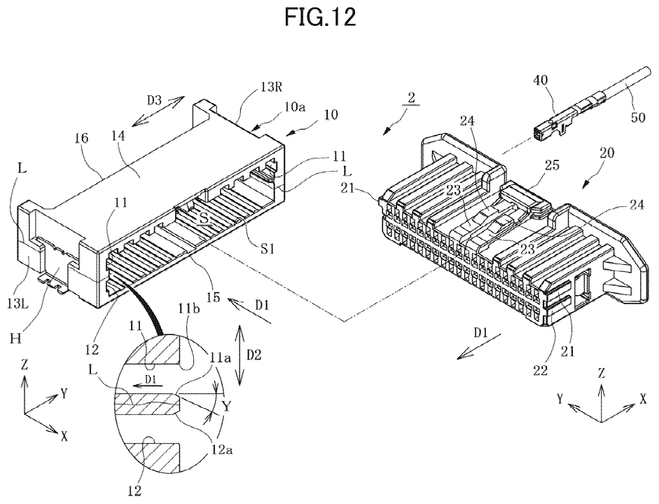

In the electrical connector 1 according to Embodiment 1, the side wall portions 13R and 13L of the housing 10a each include one first recess 11, as illustrated in FIGS. 1 and 2. However, the present disclosure is not limited thereto. As an electrical connector 2 according to Embodiment 2 illustrated in FIGS. 11 and 12, side wall portions 13R and 13L of a housing 10a of a male connector 10 may include, in addition to first recesses 11, a second recess 12. In this case, a female connector 20 includes, in addition to first protrusions 21, a second protrusion 22 extending along an insertion direction D1 with a space from the first protrusion 21.

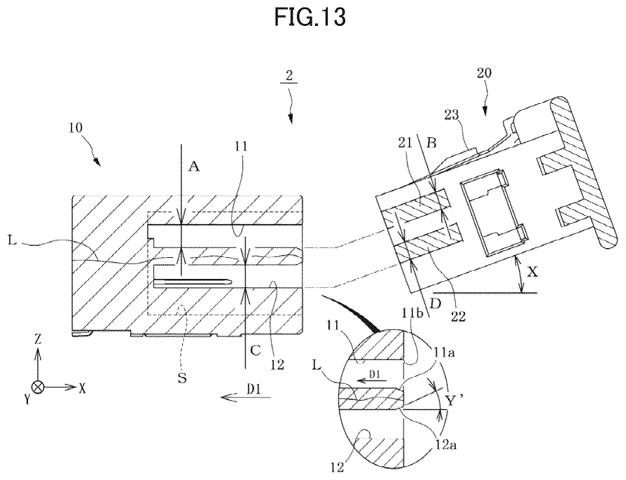

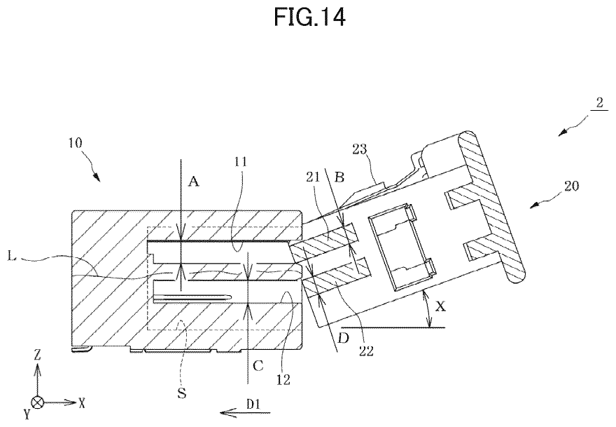

The second recess 12 is provided on one side wall portion 13L of the side wall portions 13R and 13L. As illustrated in FIGS. 13 and 14, the second recess 12 extends along the insertion direction D1 with a space from the first recess 11. In Embodiment 2, the second recess 12 is not provided to the other side wall portion 13R of the side wall portions 13R and 13L. Furthermore, in Embodiment 2, weld lines L are provided between the second recess 12 and the first recess 11. Furthermore, as illustrated in FIGS. 12 and 13, an inclined surface 12a is provided on an upper edge of an opening of the second recess 12. The inclined surface 12a is inclined at a predetermined angle relative to the insertion direction D1. The inclined surface 12a is provided to facilitate the fitting of the second protrusion 22 into the second recess 12, as well as to guide the insertion of the second protrusion 22 of the female connector 20, upon insertion of the female connector 20 into the male connector 10. In Embodiment 2, an inclination angle Y′ of the inclined surface 12a is the same as an inclination angle Y of the inclined surface 11a (Y=Y′). However, the present disclosure is not limited thereto. The inclination angle Y′ of the inclined surface 12a is not necessarily the same as the inclination angle Y of the inclined surface 11a (Y+Y′). The inclination angle Y′ of the inclined surface 12a, however, preferably approximates to the inclination angle Y of the inclined surface 11a.

As illustrated in FIGS. 11 and 12, the second protrusion 22 is provided to a side surface on the −Y side of the side surface on the −Y side and the side surface on the +Y side of the housing 20a. The second protrusion 22 has a shape of a convexity that elongates along the insertion direction D1, and fits in the second recess 12. As illustrated in FIGS. 13 and 14, the second protrusion 22 extends along the insertion direction D1 with a space from the first protrusion 21. In Embodiment 2, the second protrusion 22 is not provided to the other side surface on the +Y side of the side surface on the −Y side and the side surface on the +Y side of the housing 20a.

The electrical connector 2 with the configurations described above satisfies relation equations

$$A > α \times B \qquad ( 1 )$$

$$C > α \times D \qquad ( 7 )$$

$$( where 1 \leq α \leq 1.0641 )$$

$$25 ° \leq Y = {Y}^{′} \leq 45 ° \qquad ( 8 )$$

provided that a dimension of the groove of the first recess 11 is A, a dimension of a width of the first protrusion 21 is B, a dimension of the groove of the second recess 12 is C, a dimension of the width of the second protrusion 22 is D, and an inclination angle of the inclined surface 11a relative to the insertion direction D1 is Y.

Specifically, the electrical connector 2 according to Embodiment 2 satisfies relation equations

$$A / B = C / D = 1.0641 ( α = 1.0641 ) \qquad ( 9 )$$

$$25 ° \leq Y = {Y}^{′} \leq 45 ° . \qquad ( 10 )$$

As described above, in the electrical connector 2 according to Embodiment 2, the dimension A of the groove of the first recess 11, the dimension B of the width of the first protrusion 21, the dimension C of the groove of the second recess 12, the dimension D of the width of the second protrusion 22, and the inclination angles Y and Y′ of the inclined surfaces 11a and 12a relative to the insertion direction D1 satisfy the aforementioned relation equations. Therefore, it can suppress the angle of insertion of the female connector 20 into the male connector 10 from increasing. As a result, in Embodiment 2, damage that may occur upon insertion of the female connector 20 into the male connector 10 can be suppressed.

Furthermore, in Embodiment 2, the weld lines L are provided between the first recess 11 and the second recess 12. That is, the second recess 12 and the weld lines L are not provided at the same position in the height direction D2. Therefore, compared to a structure in which the second recess 12 and the weld lines L are provided at the same position in the height direction D2, the aforementioned structure can suppress damage such as cracks in the second recess 12 and the weld lines L. As a result, in Embodiment 2, damage that may occur upon insertion of the female connector 20 into the male connector 10 can be suppressed.

The configuration in Embodiment 2 also produces the same advantageous effects as in Embodiment 1.

Although embodiments of the present disclosure are described above, the present disclosure is not limited to the aforementioned embodiments.

For example, in Embodiment 1, the first recesses 11 of the side wall portions 13R and 13L are provided on the +Z side (one side) in the height direction D2 of the male connector 10 than the position where the weld lines L are provided, as illustrated in FIG. 7. However, the present disclosure is not limited thereto. The first recesses 11 may be arranged on the −Z side (the other side) in the height direction D2 than the position where the weld lines L are provided.

Furthermore, in Embodiment 2, the weld lines L are provided between the first recess 11 and the second recess 12, as illustrated in FIGS. 13 and 14. However, the present disclosure is not limited thereto. The weld line L may not be provided between the first recess 11 and the second recess 12.

Furthermore, in Embodiment 1, the gate traces 17 are provided at the center in the width direction D3, and at least a pair of the gate traces 17 is provided along the height direction D2, as illustrated in FIG. 3. However, the present disclosure is not limited thereto. Three or more gate traces 17 may be provided. In such a case, the three or more gate traces 17 may preferably be provided at the center in the width direction D3 and along the height direction D2.

As illustrated in FIG. 3, the pair of gate traces 17 according to Embodiment 1 have different sizes. However, the present disclosure is not limited thereto. The pair of gate traces 17 may have the same size.

### Embodiment 3

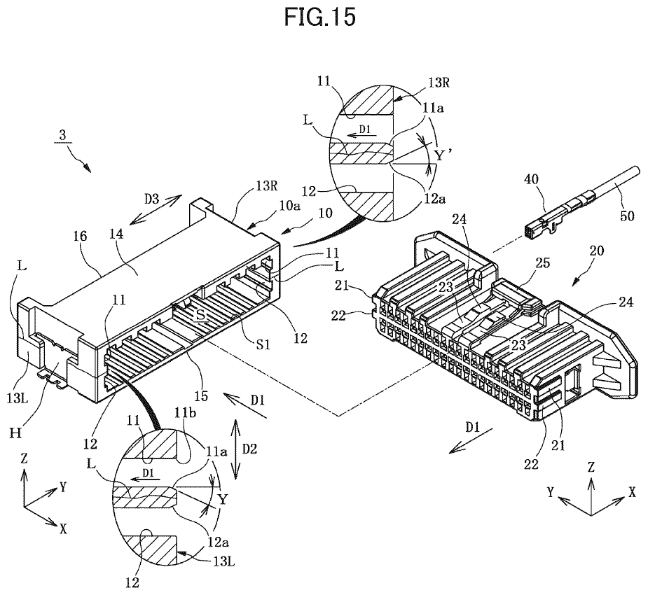

In Embodiment 2, the second recess 12 is provided on the one side wall portion 13L of the side wall portions 13R and 13L, as illustrated in FIG. 11. However, the present disclosure is not limited thereto. As an electrical connector 3 according to Embodiment 3 illustrated in FIG. 15, second recesses 12 may be provided to both side wall portions 13R and 13L. In this case, second protrusions 22 are provided to both of a side surface on the −Y side and a side surface on the +Y side of a housing 20a of a female connector 20.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.
1, 1A, 2, 3 Electrical connector
10 Male connector
10a Housing
11 First recess
11a Inclined surface
11b Upper edge
12 Second recess
12a Inclined surface
13R, 13L Side wall portion
14 Ceiling portion
15 Bottom portion
16 Rear-side wall portion
16a Portion (Portion where rear-side wall portion is formed)
17 Gate trace
20 Female connector
20a Housing
21 First protrusion
22 Second protrusion
23 Locking arm
24 Engaging section
25 Operative tap
30 Male terminal
40 Female terminal
50 Cable
80A, 80B Injection mold
81, 82 Gate
90 Circuit board
H Retainer
L Weld line
S Housing space
S1 Opening
A, C Dimension (of groove)
B, D Dimension (of width)
D1 Insertion direction
D2 Height direction
D3 Width direction
X, Y, Y Inclination angle
F Force (to open in height direction)

### INDUSTRIAL APPLICABILITY

The present disclosure is suitable for use in an electrical connector as an automobile component.

What is claimed is:

1. An electrical connector, comprising:
a male connector in which a housing space and an opening leading from the housing space to an outside are formed; and
a female connector to be inserted into the male connector from the opening of the housing space in an insertion direction, wherein
the male connector includes surface portions that define the housing space, the surface portions including a first recess that has a shape of a groove extending along the insertion direction,
the female connector includes a first protrusion that has a shape of a convexity extending along the insertion direction, and fitting in the first recess,
the first recess of the male connector includes an inclined surface, the inclined surface being inclined relative to the insertion direction, and
the male connector and the female connector satisfy relation equations
$$A > α \times B \qquad ( 1 )$$
$$( where 1 \leq α \leq 1.0641 )$$
$$25 ° \leq Y \leq 45 ° \qquad ( 2 )$$
provided that a dimension of the groove of the first recess is A, a dimension of a width of the first protrusion is B, and an inclination angle of the inclined surface relative to the insertion direction is Y.

2. The electrical connector according to claim 1, wherein
a value A/B obtained by dividing the dimension A of the groove of the first recess by the dimension B of the width of the first protrusion satisfies a relation equation
$$A / B = 1.0641 . \qquad ( 3 )$$

3. The electrical connector according to claim 1, wherein
the male connector is made of a material of solidified molten resin,
the surface portions of the male connector that define the housing space include a pair of side wall portions, a ceiling portion, and a bottom portion, the ceiling portion and the bottom portion connecting the pair of side wall portions,
in the pair of side wall portions, weld lines that are linearly occurred upon molding of molten resin are formed to extend long the insertion direction, and
the first recesses are arranged to the pair of side wall portions on one side in a height direction of the male connector than a position where the weld lines are provided.

4. The electrical connector according to claim 3, wherein
at least one side wall portion of the pair of the side wall portions includes a second recess that extends along the insertion direction with a space from the first recess, and
the weld line is provided between the first recess and the second recess.

5. The electrical connector according to claim 4, wherein
the female connector includes a second protrusion that has a shape of a convexity extending along the insertion direction, and fitting in the second recess.

6. The electrical connector according to claim 3, wherein
the male connector includes at least a pair of gate traces that are inlets for inflow therethrough of the molten resin, the at least the pair of gate traces being provided at a center in a width direction perpendicular to the insertion direction and the height direction of the male connector, and provided along the height direction of the male connector.

7. The electrical connector according to claim 6, wherein
the pair of gate traces have different sizes.
